(19) United States
(12) Patent Application Publication
(10) Pub. No.: US 2016/0134849 A1
(43) Pub. Date: May 12, 2016

(54) PROJECTING METHOD AND PROJECTING SYSTEM

(71) Applicant: PixArt Imaging Inc., Hsin-Chu City (TW)

(72) Inventor: Guo-Zhen Wang, Hsin-Chu City (TW)

(21) Appl. No.: 14/816,069

(22) Filed: Aug. 3, 2015

(30) Foreign Application Priority Data
Nov. 12, 2014 (TW) 103139272

(51) Int. Cl. H04N 9/31; G06T 7/00

(52) U.S. Cl. CPC H04N 9/3147; H04N 9/3173; H04N 9/3182; H04N 9/3185; G06T 7/0018; G06T 2207/10024; G06T 2207/20212

(57) ABSTRACT

A projecting method, comprising: (a) detecting a distance between a first projecting apparatus and a first projecting region to generate first distance information; (b) calibrating a first initial projecting image to generate a first calibrated projecting image according to the first distance information; and (c) projecting the first calibrated projecting image to the first projecting region via the first projecting apparatus. The method can further comprise applying another second projecting apparatus to generate a combined image. A corresponding image projecting system is also disclosed.

### BACKGROUND OF THE INVENTION

1. Field of the Invention

The present invention relates to a projecting method and a projecting system, and particularly relates to a projecting method and a projecting system for a surface with a non-constant curvature.

2. Description of the Prior Art

FIG. 1A, FIG. 1B, and FIG. 1C are schematic diagrams illustrating a prior art projecting apparatus. The projecting apparatus 100 for prior art is always applied to a surface with a constant curvature, for example, the flat surface FS in FIG. 1A, the convex surface PS in FIG. 1B, or the concave surface CS in FIG. 1C. In FIG. 1B and FIG. 1C, even the image is distorted, it can be fixed by a fixed process based on a geometric shape or brightness of the image. However, if the image is project on a surface with a non-constant curvature, for example, a rough and uneven wall, or a wall with many decorations, or a desktop with a plurality of stuffs. Such image may be seriously distorted and cannot be fixed, thus the user still see a distorted image.

Besides, if the image to be projected is larger, it must be generated via combining projected images from a plurality of projecting apparatuses. However, it is hard to combine images on a surface with a non-constant curvature.

### SUMMARY OF THE INVENTION

One objective of the present invention is to provide a projecting system and a projecting method, to project an image to a surface with a non-constant curvature.

One objective of the present invention is to provide a projecting system and a projecting method, to combine images on a surface with a non-constant curvature.

One embodiment of the present invention provides a projecting method, which comprises: (a) detecting a distance between a first projecting apparatus and a first projecting region to generate first distance information; (b) calibrating a first initial projecting image according to the first distance information to generate a first calibrated projecting image; and (c) projecting the first calibrated projecting image to the first projecting region via the first projecting apparatus.

Another embodiment of the present invention provides a projecting system corresponding to above-mentioned method. The projecting system comprises a first projecting apparatus. The first projecting apparatus comprises: a first image processing module; a first distance detecting module, arranged to detect a distance between a first projecting apparatus and a first projecting region to generate first distance information a first control unit, arranged to control the first image processing module to calibrate a first initial projecting image according to the first distance information to generate a first calibrated projecting image; and a first projecting module, arranged to project the first calibrated projecting image to the first projecting region.

Another embodiment of the present invention provides a projecting method, which comprises: (a) detecting a distance between a first projecting apparatus and a first projecting region to generate first distance information; (b) detecting a distance between a second projecting apparatus and a second projecting region to generate second distance information; (c) computing combination for a first projecting image and a second projecting image according to the first distance information and the second distance information to generate a combined image, wherein the first projecting image is an image that the first projecting apparatus prepares to project to the first projecting region, and the second projecting image is an image that the second projecting apparatus prepares to project to the second projecting region; and (d) applying the first projecting apparatus and the second projecting apparatus to respectively project a part of the combined image to generate the combined image.

Another embodiment of the present invention provides a projecting system corresponding to above-mentioned method. The projecting system comprises a first projecting apparatus and a second projecting apparatus. The first projecting apparatus comprises: a first distance detecting module, arranged to detect a distance between a first projecting apparatus and a first projecting region to generate first distance information; a first image processing module; a first control unit; and a first projecting module. The second projecting apparatus comprises: a second distance detecting module, arranged to detect a distance between a second projecting apparatus and a second projecting region to generate second distance information; a second image processing module; a second control unit; and a second projecting module. The first control unit or the second control unit controls the first image processing module and the second image processing module to compute combination for a first projecting image and a second projecting image according to the first distance information and the second distance information to generate a combined image, wherein the first projecting image is an image that the first projecting module prepares to project to the first projecting region, and the second projecting image is an image that the second projecting module prepares to project to the second projecting region. The first control unit or the second control unit controls the first image processing module and the second image processing module to respectively project a part of the combined image to generate the combined image.

In view of above-mentioned embodiments, the projecting apparatus and the projecting method provided by the present invention can project to a surface with a non-constant curvature via one or more projecting apparatuses. If the projecting apparatus and the projecting method provided by the present invention are applied to a portable electronic apparatus, the portable electronic apparatus can project an image to a non-flat surface. By this way, the images can be projected to more places.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A, FIG. 1B, and FIG. 1C are schematic diagrams illustrating a prior art projecting apparatus.

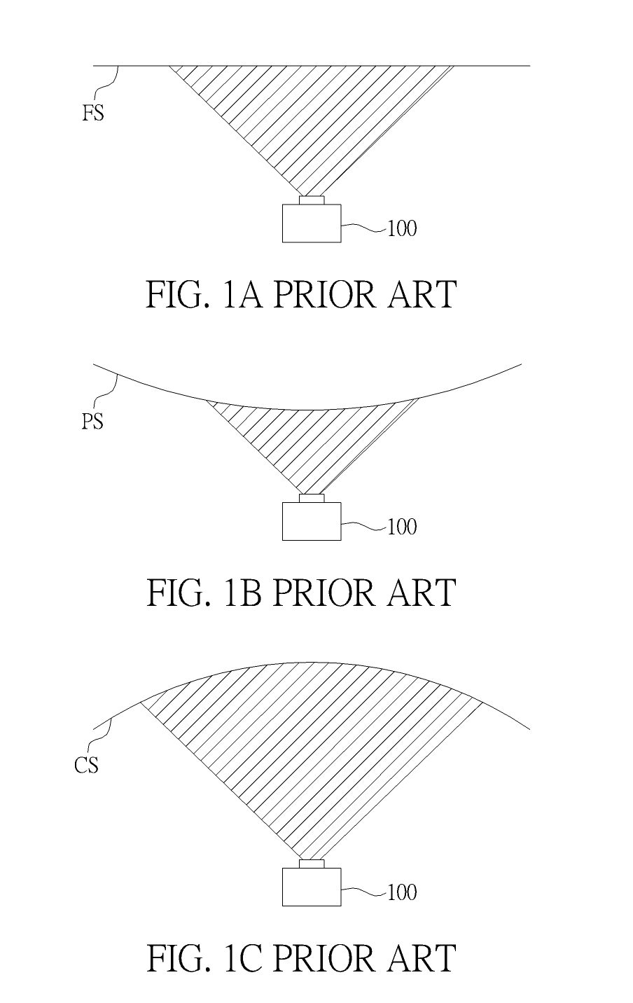

FIG. 2 is a schematic diagram illustrating a projecting apparatus according to one embodiment of the present invention.

FIG. 3 is a block diagram illustrating an inner structure for a projecting apparatus according to one embodiment of the present invention.

FIG. 4 is a schematic diagram illustrating how the projecting apparatus in FIG. 3 operates.

FIG. 5 is a flow chart illustrating a projecting method according to one embodiment of the present invention.

FIG. 6 is a schematic diagram illustrating one embodiment of the present invention, which applies a plurality of projecting apparatuses to generate a combined image.

FIG. 7 is a block diagram illustrating an inner structure for another projecting apparatus in FIG. 6.

FIG. 8 is a schematic diagram illustrating how the projecting apparatuses in FIG. 6 operate.

FIG. 9 is a flow chart illustrating a projecting method according to another embodiment of the present invention.

FIG. 10 is a schematic diagram illustrating how the projecting apparatus provided by the present invention is applied to a portable electronic apparatus.

### DETAILED DESCRIPTION

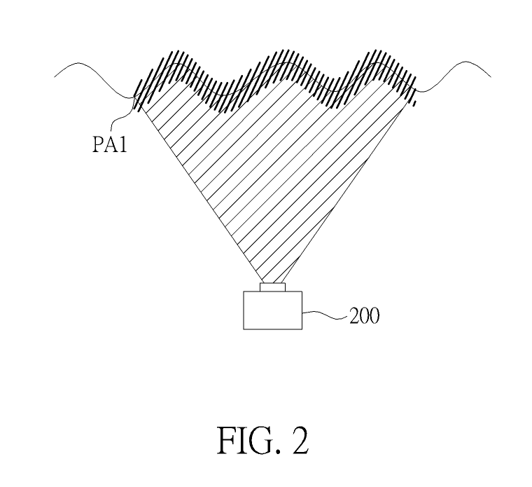

FIG. 2 is a schematic diagram illustrating a projecting apparatus according to one embodiment of the present invention. As depicted in FIG. 2, the projecting apparatus 200 projects an image to a projecting region PA1, which is a surface with a non-constant curvature. Please note the projecting apparatus and the projecting method according to the present invention are not limited to be applied to the projecting region PA1 shown in FIG. 2. The projecting apparatus and the projecting method according to the present invention can be applied to be other surfaces having non-constant curvatures, and can be applied to surfaces with constant curvatures as well.

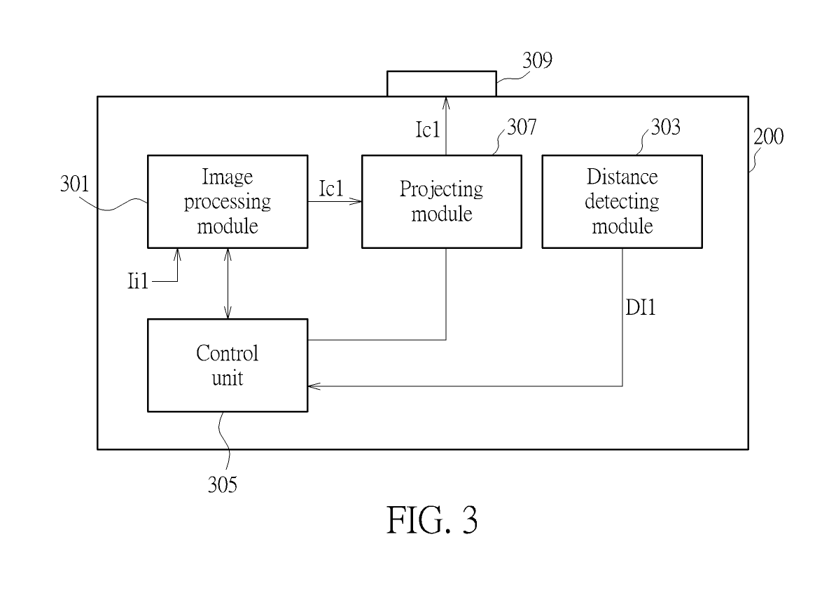

FIG. 3 is a block diagram illustrating an inner structure for a projecting apparatus according to one embodiment of the present invention. As shown in FIG. 3, the projecting apparatus 200 comprises an image processing module 301, a distance detecting module 303, a control unit 305, a projecting module 307 and a lens 309. The distance detecting module 303 is arranged to detect a distance between the projecting apparatus 200 and a projecting region PA1 in FIG. 2 to generate distance information DI1. The control unit 305 is arranged to control the image processing module 301 to calibrate an initial projecting image Ii1 according to the distance information DI1 to generate a calibrated projecting image Ic1. After that, the image processing module 301 transmits the calibrated projecting image Ic1 to the projecting module 307. The control unit 305 controls the projecting module 307 to project the calibrated projecting image Ic1 to the projecting region PA1 via the lens 309. It will be appreciated that the projecting module 307 comprises devices for projecting an image, such as a light emitting device. The detail structure for the projecting module 307 is well known by persons skilled in the art, thus it is omitted for brevity here. The initial projecting image Ii1 is from an image stored in the projecting apparatus 200 or an external image.

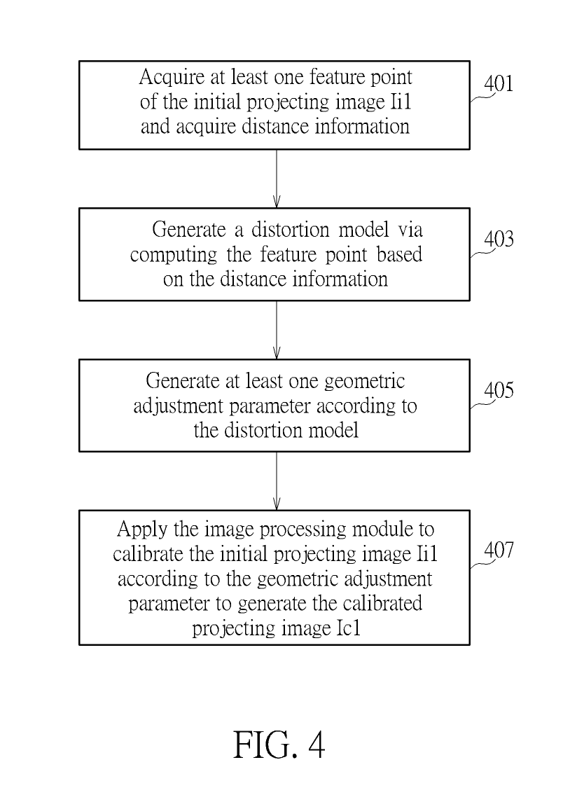

FIG. 4 is a schematic diagram illustrating how the projecting apparatus in FIG. 3 operates, which comprises but not limited to following steps:

### Step 401

Acquire at least one feature point of the initial projecting image Ii1 and acquire distance information DI1.

### Step 403

Generate a distortion model via computing the feature point based on the distance information DI1.

### Step 405

Generate at least one geometric adjustment parameter according to the distortion model.

### Step 407

Apply the image processing module to calibrate the initial projecting image Ii1 according to the geometric adjustment parameter to generate the calibrated projecting image Ic1.

Please note, the present invention is not limited to apply the structure in FIG. 3 and steps in FIG. 4 to calibrate the initial projecting image Ii1 according to distance information to generate the calibrated projecting image Ic1. Also, the above-mentioned distance information DI1 can be acquired by many methods, for example, the US applications with publication numbers US 20110134078 and US20130293867 have disclosed the methods for detecting distance information. Besides, the feature points in the step 403 can be specific object images or image points with specific brightness values. Besides, it is well known by persons skilled in the art to calibrate an image based on the distortion model and the geometric adjustment parameters. For example, the feature point in the step 403 is an image for a tree, thus the step 403 determines how to calibrate an image based on distance information and a height and width for the image of the tree. That is, generate a distortion model and geometric adjustment parameters. Persons skilled in the art can understand the definition and the detail steps for the distortion model and geometric adjustment parameters, thus are omitted for brevity here.

In view of above-mentioned embodiments, a projecting method can be acquired, which comprises following steps:

### Step 501

Detect a distance between a first projecting apparatus (ex. 200 in FIG. 2) and a first projecting region (ex. PA1 in FIG. 2) to generate first distance information (ex. DI1 in FIG. 3).

### Step 503

Calibrate a first initial projecting image (ex. Ii1 in FIG. 3) according to the first distance information to generate a first calibrated projecting image (ex. Ic1 in FIG. 3).

### Step 505

Project the first calibrated projecting image to the first projecting region via the first projecting apparatus.

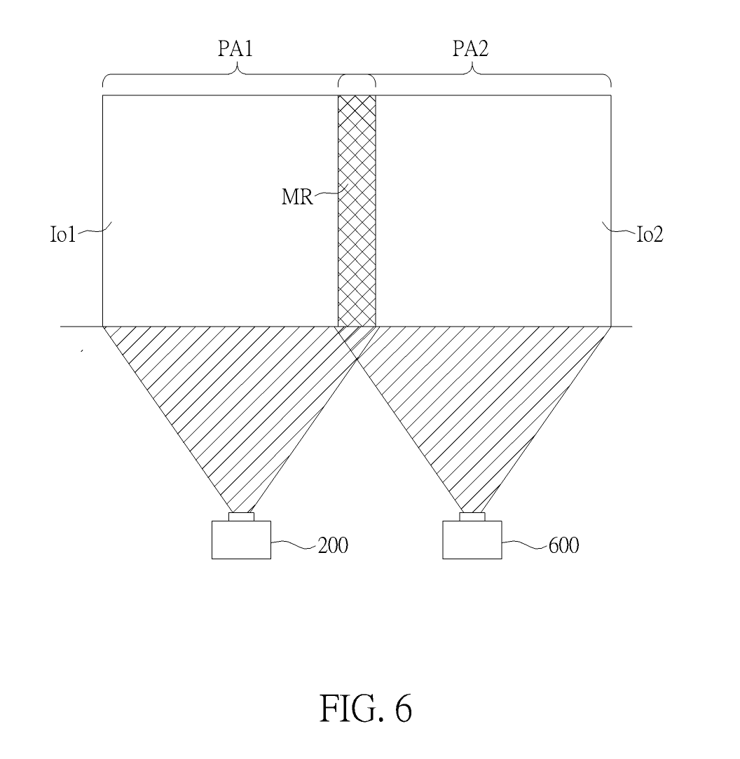

Besides the single projecting apparatus, the present invention also provides an embodiment for applying a plurality of projecting apparatuses to generate a combined image. FIG. 6 is a schematic diagram illustrating one embodiment of the present invention, which applies a plurality of projecting apparatuses to generate a combined image. As shown in FIG. 6, besides, the projecting apparatus 200 in above-mentioned embodiments, another projecting apparatus 600 is further included. In such example, the projecting apparatuses 200 and 600 can be regarded as a projecting system. The projecting apparatus 200 generates a projecting image Io1, and the projecting apparatus 600 generates another projecting image Io2. The projecting apparatus 200 or the projecting apparatus 600 combine the projecting image Io1 and the projecting image Io2. In one embodiment, the projecting image Io1 can be an initial projecting image which is not calibrated (Ii1 in FIG. 2) or a calibrated projecting image (Ic1 in FIG. 2). Similarly, the projecting image Io2 can be an initial projecting image which is not calibrated or a calibrated projecting image.

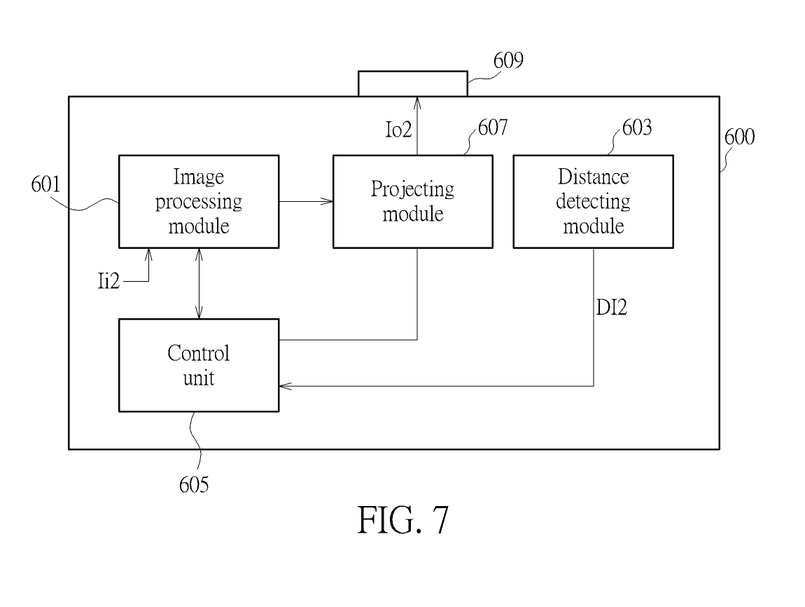

FIG. 7 is a block diagram illustrating an inner structure for another projecting apparatus 600 in FIG. 6. Please refer to FIG. 3, FIG. 6 and FIG. 7 together to understand the content of the present invention for more clear. As depicted in FIG. 7, the projecting apparatus 600 comprises an image processing module 601, a distance detecting module 603, a control unit 605, a projecting module 607 and a lens 609. Devices and operations for the projecting apparatus 600 are the same as which of the projecting apparatus 200, thus descriptions thereof are omitted for brevity here. Since an initial projecting image which is not calibrated is desired to be output, the image processing module 601 does not calibrate the initial image Ii2, and the projecting module 607 directly outputs the initial image Ii2 as the projecting image Io2. If a calibrated projecting image is desired to be output, the image processing module 601 does calibrates the initial image Ii2, and the projecting module 607 outputs the calibrated image as the projecting image Io2.

In one embodiment, the projecting apparatus 200 outputs the projecting image Io1 first, and then the projecting apparatus 600 outputs the projecting image Io2. After that, the projecting image Io1 and the projecting image Io2 are combined. In such case, the distance detecting module 603 of the projecting apparatus 600 detects a distance between the projecting apparatus 600 and a projecting region (PA2 in FIG. 6) to generate distance information (DI2 in FIG. 7). Also, the projecting apparatus 600 projects a projecting image Io2 to the projecting region PA2. Besides, the control unit 305 in FIG. 3 or the control unit 605 in FIG. 7 combines the projecting images Io1 and Io2 according to distance information DI1 and DI2. In another embodiment, the combination for the projecting images Io1 and Io2 is performed in a combining region (MR in FIG. 6). That is, the control unit 305 or 605 adjusts the projecting image Io1 and Io2, which is prepared to be output, according to the image in the combining region MR. The combining region is included in the projecting region RA1 and included in the projecting region RA2. Also, a distance between the combining region MR and the projecting apparatus 200 is the same as a distance between the combining region MR and the projecting apparatus 600.

In another embodiment, the combination for the images is computed first, and then the image is projected. In such embodiment, the distance detecting module 303 of the projecting apparatus 200 detects distance information DI1 between the projecting apparatus 200 and the projecting region RA1, and the distance detecting module 603 of the projecting apparatus 600 detects distance information DI2 between the projecting apparatus 600 and the projecting region RA2. After that, the control unit 305 in FIG. 3 or the control unit 605 in FIG. 7 controls the image processing modules in the projecting apparatuses 200 and 600 to compute combination of the first projecting image and the second projecting image to generate a combined image. The first projecting image is an image that the projecting module 200 prepares to project to the first projecting region RA1, and the second projecting image is an image that the projecting module 600 prepares to project to the second projecting region RA2. After the combined image has been computed, the control unit 205 in the projecting apparatus 200 or the control unit 605 in the projecting apparatus 600 controls the projecting apparatuses 200 and 600 to respectively project a part of the combined image to the projecting region RA1 and the projecting region RA2, to generate the combined image.

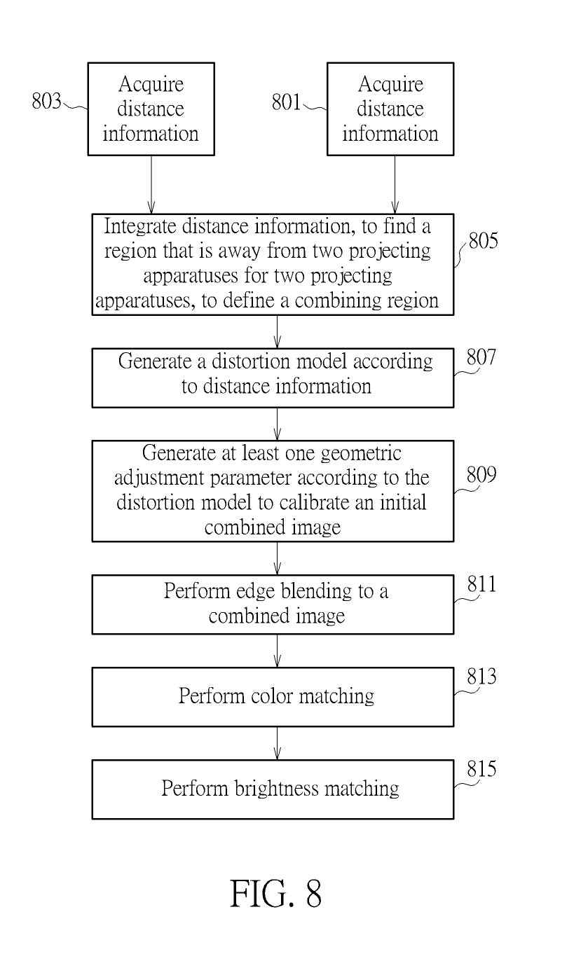

FIG. 8 is a schematic diagram illustrating how the projecting apparatuses in FIG. 6 operate, which comprises following steps:

### Step 801

Acquire distance information DI1.

### Step 803

Acquire distance information DI2.

### Step 805

Integrate distance information DI1 and DI2, to find a region that is away from two projecting apparatuses for two projecting apparatuses, to define a combining region MR.

### Step 807

Generate a distortion model according to distance information DI1, DI2. In one embodiment, feature points are applied to compute the distortion model, which have been described in above-mentioned embodiments.

### Step 809

Generate at least one geometric adjustment parameter according to the distortion model to calibrate an initial combined image.

### Step 811

Perform edge blending to a combined image.

### Step 813

Perform color matching, which means adjusting the color of the combined image.

### Step 815

Perform brightness matching, which means adjusting brightness of the combined image.

The steps in FIG. 8 can be performed before projecting an image or after projecting an image. Please note the steps for generating a combined image is not limited to the steps stated in FIG. 8.

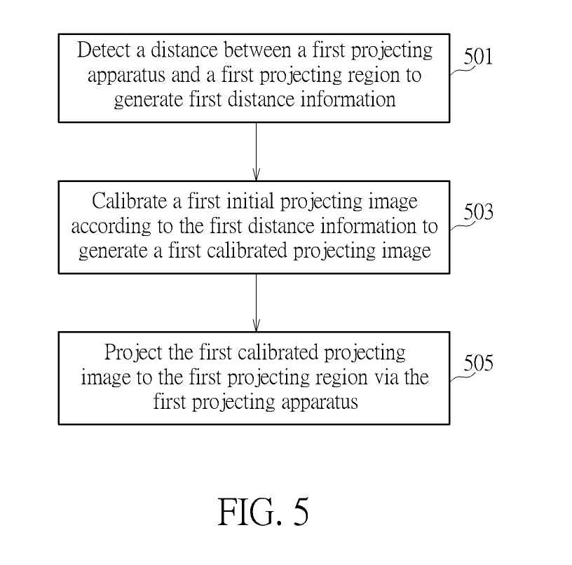

In view of above-mentioned embodiments, a following projecting method can be acquired. If the steps for combining images are performed after projecting, FIG. 5 can further comprise following steps: detecting a distance between a second projecting apparatus (ex. 600 in FIG. 6) and a second projecting region (ex. PA2 in FIG. 6) to generate second distance information (ex. DI2 in FIG. 7); projecting a second projecting image to the second projecting region via the second projecting apparatus; and combining the first calibrated projecting image and the second projecting image according to the first distance information and the second distance information. As above-mentioned, the second projecting image can be a calibrated image or an image which is not calibrated.

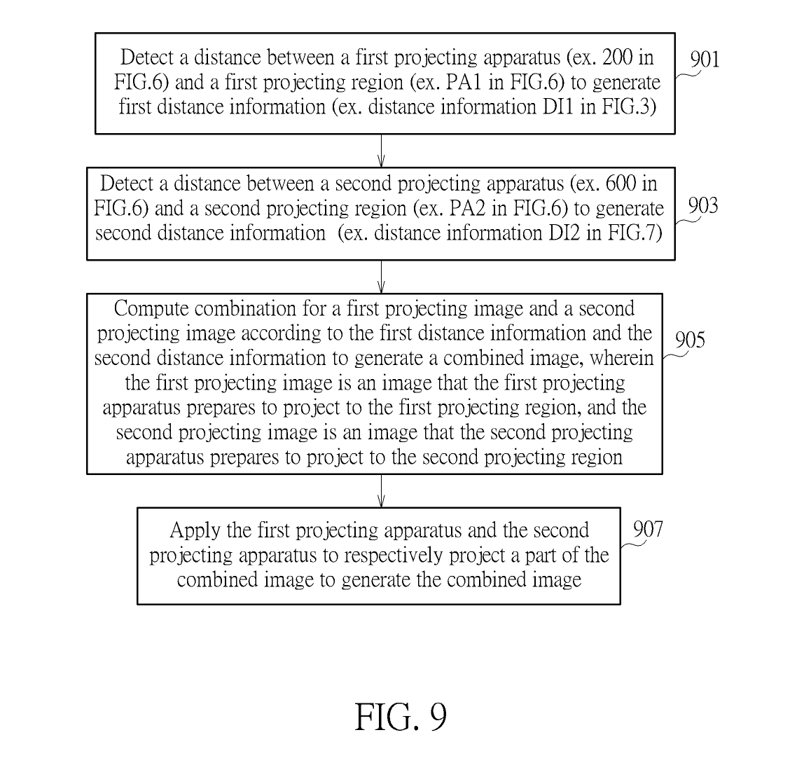

If the steps for generating a combining image are projecting after computing the combined image, the steps in FIG. 9 are included, which are depicted as follows:

### Step 901

Detect a distance between a first projecting apparatus (ex. 200 in FIG. 6) and a first projecting region (ex. PA1 in FIG. 6) to generate first distance information (ex. distance information DI1 in FIG. 3).

### Step 903

Detect a distance between a second projecting apparatus (ex. 600 in FIG. 6) and a second projecting region (ex. PA2 in FIG. 6) to generate second distance information (ex. distance information DI2 in FIG. 7).

### Step 905

Compute combination for a first projecting image and a second projecting image according to the first distance information and the second distance information to generate a combined image, wherein the first projecting image is an image that the first projecting apparatus prepares to project to the first projecting region, and the second projecting image is an image that the second projecting apparatus prepares to project to the second projecting region

### Step 907

Apply the first projecting apparatus and the second projecting apparatus to respectively project a part of the combined image to generate the combined image.

The above-mentioned projecting apparatus and projecting method are not limited to a traditional projecting apparatus, which are large, heavy, need to be put on a desk or hanged on a wall. The above-mentioned projecting apparatus and projecting method can be applied to smaller projecting apparatuses, which are portable, or can be integrated to portable electronic apparatuses.

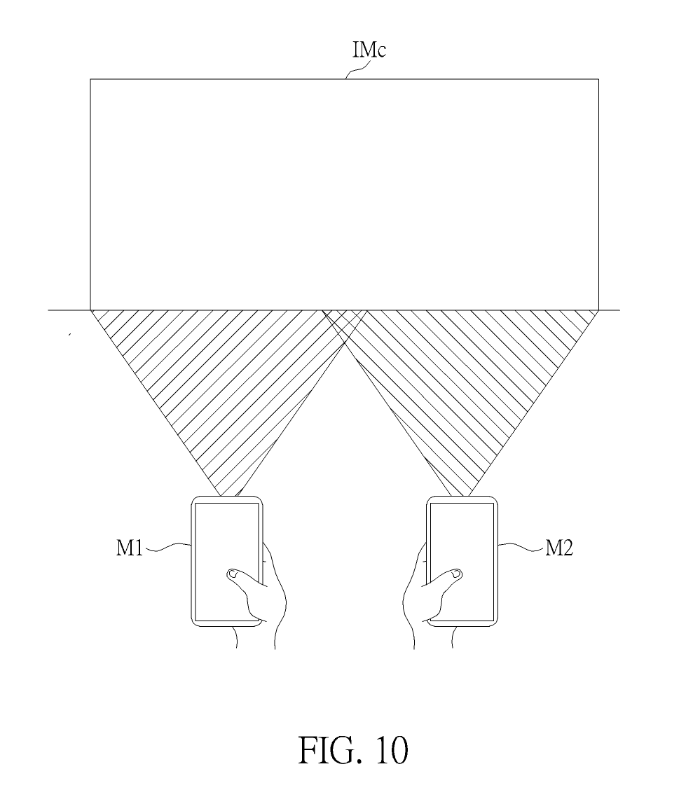

FIG. 10 is a schematic diagram illustrating how the projecting apparatus provided by the present invention is applied to a portable electronic apparatus. As shown in FIG. 10, portable electronic apparatuses M1, M2 (ex. a mobile phone, or a portable electronic apparatus which comprises only projecting function) respectively comprises a projecting apparatus included therein. In such case, the user can directly apply the portable electronic apparatuses M1, M2, by handheld or put at any place, to generate a combined image IMc at any desired place. Of course, the user can apply only one portable electronic apparatus to generate the image. Since the above-mentioned calibrating steps or combining steps are applied, portable electronic apparatuses M1, M2 are not limited to project at a surface with a constant curvature, thus the images can be projected to more places.

It will be appreciated that the embodiments for generating a combined image is not limited to two projecting apparatuses, but also can be applied to more than two projecting apparatuses.

In view of above-mentioned embodiments, the projecting apparatus and the projecting method provided by the present invention can project to a surface with a non-constant curvature via one or more projecting apparatuses. If the projecting apparatus and the projecting method provided by the present invention are applied to a portable electronic apparatus, the portable electronic apparatus can project an image to a non-flat surface. By this way, the images can be projected to more places.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projecting method, comprising:
(a) detecting a distance between a first projecting apparatus and a first projecting region to generate first distance information;
(b) calibrating a first initial projecting image according to the first distance information to generate a first calibrated projecting image; and
(c) projecting the first calibrated projecting image to the first projecting region via the first projecting apparatus.

2. The projecting method of claim 1, wherein the step (b) comprises:
acquiring at least one feature point of the first initial projecting image;
generating a distortion model via computing the feature point based on the first distance information;
generating at least one geometric adjustment parameter according to the distortion model; and
applying the first projecting apparatus to calibrate the first initial projecting image according to the geometric adjustment parameter to generate the first calibrated projecting image.

3. The projecting method of claim 1, wherein a surface of the first projecting region is a surface with a non-constant curvature.

4. The projecting method of claim 1, wherein the first projecting apparatus is a portable electronic apparatus.

5. The projecting method of claim 1, further comprising:
(d) detecting a distance between a second projecting apparatus and a second projecting region to generate second distance information;
(e) projecting a second projecting image to the second projecting region via the second projecting apparatus; and
(f) combining the first calibrated projecting image and the second projecting image according to the first distance information and the second distance information.

6. The projecting method of claim 5, wherein the step (f) combines the first calibrated projecting image and the second projecting image in a combining region, wherein the combining region is included in the first projecting region and included in the second projecting region, wherein a distance between the combining region and the first projecting apparatus is the same as a distance between the combining region and the second projecting apparatus.

7. The projecting method of claim 5, wherein the step (e) further comprises:
calibrating a second initial projecting image according to the second distance information to generate the second projecting image.

8. The projecting method of claim 5, wherein the first projecting apparatus and the second projecting apparatus are portable electronic apparatuses.

9. A projecting method, comprising:
(a) detecting a distance between a first projecting apparatus and a first projecting region to generate first distance information;
(b) detecting a distance between a second projecting apparatus and a second projecting region to generate second distance information;
(c) computing combination for a first projecting image and a second projecting image according to the first distance information and the second distance information to generate a combined image, wherein the first projecting image is an image that the first projecting apparatus prepares to project to the first projecting region, and the second projecting image is an image that the second projecting apparatus prepares to project to the second projecting region; and
(d) applying the first projecting apparatus and the second projecting apparatus to respectively project a part of the combined image to generate the combined image.

10. The projecting method of claim 9, wherein the combined image comprises a combining region image corresponding to a combining region, wherein the combining region is included in the first projecting region and included in the second projecting region, wherein a distance between the combining region and the first projecting apparatus is the same as a distance between the combining region and the second projecting apparatus.

11. The projecting method of claim 9, wherein the first projecting apparatus and the second projecting apparatus are portable electronic apparatuses.

12. The projecting method of claim 9, wherein the step(c) comprises following steps to generate the combined image:
acquiring at least one feature point of the first projecting image and the second projecting image;
generating a distortion model via computing the feature point based on the first distance information and the second distance information;
generating at least one geometric adjustment parameter according to the distortion model; and
applying the first projecting apparatus and the second projecting apparatus to calibrate the first projecting image and the second projecting image according to the geometric adjustment parameter to generate the combined image.

13. A projecting system, comprising:
a first projecting apparatus, comprising:
a first image processing module;
a first distance detecting module, arranged to detect a distance between a first projecting apparatus and a first projecting region to generate first distance information;
a first control unit, arranged to control the first image processing module to calibrate a first initial projecting image according to the first distance information to generate a first calibrated projecting image; and
a first projecting module, arranged to project the first calibrated projecting image to the first projecting region.

14. The projecting system of claim 13, wherein the first control unit controls the first image processing module to perform following steps to generate the first calibrated projecting image:
acquiring at least one feature point of the first initial projecting image;
generating a distortion model via computing the feature point based on the first distance information;
generating at least one geometric adjustment parameter according to the distortion model; and
calibrating the first initial projecting image according to the geometric adjustment parameter to generate the first calibrated projecting image.

15. The projecting system of claim 13, wherein a surface of the first projecting region is a surface with a non-constant curvature.

16. The projecting system of claim 13, wherein the first projecting apparatus is a portable electronic apparatus.

17. The projecting system of claim 13, further comprising a second projecting apparatus, wherein the second projecting apparatus comprises:
a second image processing module;
a second distance detecting module, arranged to detect a distance between the second projecting apparatus and a second projecting region to generate second distance information;
a second control unit; and
a second projecting module, arranged to project a second projecting image to the second projecting region;
wherein the first control unit or the second control unit is arranged to control the first projecting module and the second projecting module to combine the first calibrated projecting image and the second projecting image according to the first distance information and the second distance information.

18. The projecting system of claim 17, wherein the first control unit or the second control unit is arranged to control the first projecting module and the second projecting module to combine the first calibrated projecting image and the second projecting image in a combining region, wherein the combining region is included in the first projecting region and included in the second projecting region, wherein a distance between the combining region and the first projecting apparatus is the same as a distance between the combining region and the second projecting apparatus.

19. The projecting system of claim 17, wherein the second control unit further controls the second image processing module to calibrate a second initial projecting image according to the second distance information to generate the second projecting image.

20. The projecting system of claim 17, wherein the first projecting apparatus and the second projecting apparatus are portable electronic apparatuses.

21. A projecting system, comprising:
a first projecting apparatus, comprising:
a first distance detecting module, arranged to detect a distance between a first projecting apparatus and a first projecting region to generate first distance information;
a first image processing module;
a first control unit; and
a first projecting module;
a second projecting apparatus, comprising:
a second distance detecting module, arranged to detect a distance between a second projecting apparatus and a second projecting region to generate second distance information;
a second image processing module;
a second control unit; and
a second projecting module;
wherein the first control unit or the second control unit controls the first image processing module and the second image processing module to compute combination for a first projecting image and a second projecting image according to the first distance information and the second distance information to generate a combined image, wherein the first projecting image is an image that the first projecting module prepares to project to the first projecting region, and the second projecting image is an image that the second projecting module prepares to project to the second projecting region;
wherein the first control unit or the second control unit controls the first image processing module and the second image processing module to respectively project a part of the combined image to generate the combined image.

22. The projecting system of claim 21, wherein the first control unit or the second control unit controls the first image processing module and the second image processing module to perform following steps to generate the combined image:
acquiring at least one feature point of the first projecting image and the second projecting image;
generating a distortion model via computing the feature point based on the first distance information and the second distance information;
generating at least one geometric adjustment parameter according to the distortion model; and
applying the first projecting apparatus and the second projecting apparatus to calibrate the first projecting image and the second projecting image according to the geometric adjustment parameter to generate the combined image.

23. The projecting system of claim 21, wherein a combining region image of the combined image corresponds to a combining region, wherein the combining region is included in the first projecting region and included in the second projecting region, wherein a distance between the combining region and the first projecting apparatus is the same as a distance between the combining region and the second projecting apparatus.

24. The projecting system of claim 21, wherein the first projecting apparatus and the second projecting apparatus are portable electronic apparatuses.
